(19) United States
(12) Patent Application Publication
(10) Pub. No.: US 2025/0392083 A1
(43) Pub. Date: Dec. 25, 2025

(54) SECOND ELECTRICAL CONNECTOR AND CONNECTOR ASSEMBLY WITH IMPROVED SHIELDING EFFECT

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Xiaoping WU, Dongguan City (CN)

(73) Assignee: DONGGUAN LUXSHARE TECHNOLOGIES CO., LTD, Dongguan City (CN)

(21) Appl. No.: 18/901,580

(22) Filed: Sep. 30, 2024

(30) Foreign Application Priority Data
Jun. 25, 2024 (CN) 202410830851.2

(51) Int. Cl. H01R 13/6593

(52) U.S. Cl. CPC H01R 13/6593

(57) ABSTRACT

A second electrical connector includes a second housing and a second mating module mounted to the second housing. The second mating module includes a number of second cable modules and a second fixing block fixed on the second cable modules. Each second cable module includes a second terminal module, a second cable, a second shielding clamping plate clamping the second cable, and a metal shield surrounding member at least partially sleeved on the second terminal module. The second shielding clamping plate is in contact with the metal shield surrounding member, thereby increasing the ground shielding area and improving the shielding effect. A connector assembly having the second electrical connector is also disclosed.

### CROSS-REFERENCE TO RELATED APPLICATION

This patent application claims priority of a Chinese Patent Application No. 202410830851.2, filed on Jun. 25, 2024 and titled “SECOND ELECTRICAL CONNECTOR AND CONNECTOR ASSEMBLY”, the entire content of which is incorporated herein by reference.

### TECHNICAL FIELD

The present disclosure relates to a second electrical connector and a connector assembly, which belong to the technical field of connectors.

### BACKGROUND

Existing connector assemblies in the related art usually include a plug connector and a receptacle connector. The plug connector usually includes a plug housing and a plurality of plug mating modules mounted to the plug housing. Each plug mating module includes an insulating frame, a plurality of plug conductive terminals insert-molded with the insulating frame, a first metal shield disposed on one side of the insulating frame, and a second metal shield disposed on another side of the insulating frame. The plurality of plug conductive terminals include a first ground terminal, a second ground terminal and a plug signal terminal pair located between the first ground terminal and the second ground terminal. The first metal shield, the second metal shield, the first ground terminal and the second ground terminal jointly form a shielding cavity. The plug signal terminal pair includes a first contact portion located in the shielding cavity.

The receptacle connector usually includes a receptacle housing and a plurality of receptacle mating modules mounted to the receptacle housing. Each receptacle mating module includes an insulating frame, a plurality of receptacle conductive terminals insert-molded with the insulating frame, and a plurality of shielding sleeves. The plurality of receptacle conductive terminals include a plurality of receptacle signal terminal pairs. The shielding sleeve is sleeved on a corresponding receptacle signal terminal pair. The receptacle signal terminal pair includes a second contact portion.

When the plug connector is mated with the receptacle connector, the shielding sleeve of the receptacle connector module is inserted into the shielding cavity of the plug mating module. The first contact portion of the plug signal terminal pair is in contact with the second contact portion of the receptacle conductive terminal to achieve electrical conduction.

However, as shielding requirements for connectors continue to increase, there is still room for improvement in connector assemblies in the related art.

### SUMMARY

An object of the present disclosure is to provide a second electrical connector and a connector assembly with improved shielding effect.

In order to achieve the above object, the present disclosure adopts the following technical solution: a second electrical connector, including: a second housing, the second housing defining a receiving space and a plurality of second terminal receiving grooves communicating with the receiving space; the receiving space being configured to at least partially receive a first electrical connector; the second terminal receiving groove extends along a first direction; and a second mating module, the second mating module being mounted to the second housing; the second mating module including a plurality of second cable modules and a second fixing block fixed on the plurality of second cable modules; each second cable module including a second terminal module, a second cable electrically connected to the second terminal module, a second shielding clamping plate clamping the second cable, and a metal shield surrounding member at least partially sleeved on the second terminal module; the second terminal module including a second conductive terminal; the second conductive terminal including a second contact arm and a second tail portion; the second tail portion being electrically connected to the second cable; wherein the second shielding clamping plate includes a third clamping plate portion and a fourth clamping plate portion; the second cable is clamped by the third clamping plate portion and the fourth clamping plate portion; the third clamping plate portion and the fourth clamping plate portion are provided separately from the metal shield surrounding member; and wherein the second shielding clamping plate is in contact with the metal shield surrounding member; the metal shield surrounding member at least partially passes through a corresponding second terminal receiving groove to protrude into the receiving space.

In order to achieve the above object, the present disclosure adopts the following technical solution: a connector assembly, including: a first electrical connector and a second electrical connector that cooperate with each other; the first electrical connector including: a first housing, the first housing including a mating surface and a plurality of first terminal receiving grooves extending through the mating surface; and a first mating module, the first mating module including a first terminal module and a metal shielding sleeve at least partially sleeved on the first terminal module; wherein the first terminal module includes a first conductive terminal, the first conductive terminal includes a first contact portion; the metal shielding sleeve includes a first side wall, a second side wall opposite to the first side wall, a third side wall connecting one end of the first side wall and one end of the second side wall, and a fourth side wall connecting another end of the first side wall and another end of the second side wall; the metal shielding sleeve further includes a shielding cavity jointly enclosed by the first side wall, the fourth side wall, the second side wall and the third side wall; the shielding cavity being disposed corresponding to a corresponding first terminal receiving groove; the first contact portion at least partially protrudes into the shielding cavity; the second electrical connector including: a second housing, the second housing defining a receiving space and a plurality of second terminal receiving grooves communicating with the receiving space; the second terminal receiving groove extends along a first direction; and a second mating module, the second mating module including a plurality of second cable modules and a second fixing block fixed on the plurality of second cable modules; each second cable module including a second terminal module, a second cable electrically connected to the second terminal module, a second shielding clamping plate clamping the second cable, and a metal shield surrounding member at least partially sleeved on the second terminal module; the second terminal module including a second conductive terminal; the second conductive terminal including a second contact arm and a second tail portion; the second tail portion being electrically connected to the second cable; wherein the second shielding clamping plate includes a third clamping plate portion and a fourth clamping plate portion; the second cable is clamped by the third clamping plate portion and the fourth clamping plate portion; the second shielding clamping plate is in contact with the metal shield surrounding member; the metal shield surrounding member at least partially passes through a corresponding second terminal receiving groove to protrude into the receiving space; when the first electrical connector is mated with the second electrical connector, the first housing of the first electrical connector is at least partially received in the receiving space of the second housing; the metal shield surrounding member of the second electrical connector is at least partially inserted into the shielding cavity of the first electrical connector; the first contact portion of the first electrical connector is in contact with the second contact arm of the second electrical connector.

Compared with the prior art, the second electrical connector of the present disclosure is provided with the second shielding clamping plate. The second shielding clamping plate is in contact with the metal shield surrounding member, thereby increasing the grounding shielding area and improving the shielding effect.

### BRIEF DESCRIPTION OF DRAWINGS

FIG. 1 is a perspective view of a connector assembly in accordance with an embodiment of the present disclosure, in which a first electrical connector and a second electrical connector are mated together;

FIG. 2 is a partially exploded perspective view of FIG. 1, in which the first electrical connector and the second electrical connector are separated from each other;

FIG. 3 is a perspective view of the first electrical connector in FIG. 2 from another angle;

FIG. 4 is a partially exploded perspective view of the first electrical connector of FIG. 3, with a first housing separated;

FIG. 5 is a partially exploded perspective view of FIG. 4 from another angle;

FIG. 6 is a partial enlarged view of a circled portion D in FIG. 5;

FIG. 7 is a front view of the first housing in FIG. 4 when it is separated from a plurality of first mating modules;

FIG. 8 is a rear view of the first housing and the plurality of first mating modules in FIG. 4 when they are separated;

FIG. 9 is a further perspective exploded view of FIG. 4, in which a plurality of first positioning pieces are separated;

FIG. 10 is a partially exploded perspective view of FIG. 9 from another angle;

FIG. 11 is a perspective view of the first mating module in FIG. 9;

FIG. 12 is a perspective view of FIG. 11 from another angle;

FIG. 13 is a partially exploded perspective view of FIG. 11;

FIG. 14 is a partially exploded perspective view of FIG. 13 from another angle;

FIG. 15 is a partially exploded perspective view of a first cable module in FIG. 13;

FIG. 16 is a further partially exploded perspective view of FIG. 15;

FIG. 17 is a further partially exploded perspective view of FIG. 16;

FIG. 18 is a further partially exploded perspective view of FIG. 17;

FIG. 19 is a partially exploded perspective view of FIG. 15 from another angle;

FIG. 20 is a partially exploded perspective view of FIG. 16 from another angle;

FIG. 21 is a partially exploded perspective view of FIG. 17 from another angle;

FIG. 22 is a partially exploded perspective view of FIG. 18 from another angle;

FIG. 23 is a perspective view of the second electrical connector in accordance with the embodiment of the present disclosure;

FIG. 24 is a perspective view of FIG. 23 from another angle;

FIG. 25 is a front view of FIG. 23;

FIG. 26 is a rear view of FIG. 23;

FIG. 27 is a partially exploded perspective view of FIG. 23, in which a second housing is separated;

FIG. 28 is a partially exploded perspective view of FIG. 27 from another angle;

FIG. 29 is a rear view of the second housing in FIG. 27 when it is separated from a plurality of second mating modules;

FIG. 30 is a further perspective exploded view of FIG. 27, in which a plurality of second positioning pieces are separated;

FIG. 31 is a partially exploded perspective view of FIG. 30 from another angle;

FIG. 32 is a perspective view of the second mating module in FIG. 30;

FIG. 33 is a perspective view of FIG. 32 from another angle;

FIG. 34 is a partially exploded perspective view of FIG. 32;

FIG. 35 is a partially exploded perspective view of FIG. 34 from another angle;

FIG. 36 is a partially exploded perspective view of a second cable module in FIG. 34;

FIG. 37 is a further partially exploded perspective view of FIG. 36;

FIG. 38 is a further partially exploded perspective view of FIG. 37;

FIG. 39 is a further partially exploded perspective view of FIG. 38;

FIG. 40 is a partially exploded perspective view of FIG. 36 from another angle;

FIG. 41 is a partially exploded perspective view of FIG. 37 from another angle;

FIG. 42 is a partially exploded perspective view of FIG. 38 from another angle;

FIG. 43 is a partially exploded perspective view of FIG. 39 from another angle;

FIG. 44 is a perspective view of an insulating block and a second terminal module in FIG. 39 when they are separated from each other;

FIG. 45 is a perspective view of FIG. 44 from another angle;

FIG. 46 is a schematic cross-sectional view taken along line B-B in FIG. 2; and

FIG. 47 is a schematic cross-sectional view taken along line C-C in FIG. 1.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

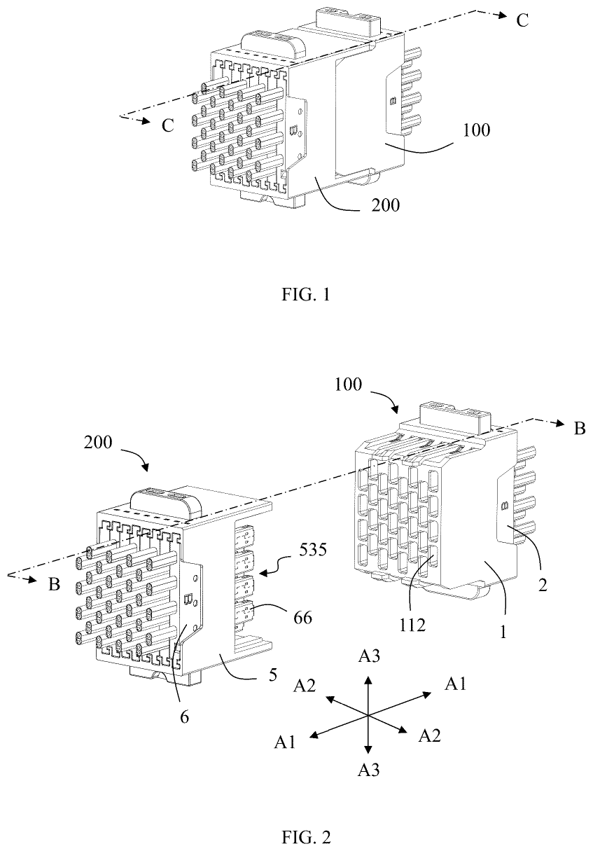

Referring to FIGS. 1 and 2, an illustrated embodiment of the present disclosure discloses a connector assembly including a first electrical connector 100 and a second electrical connector 200 for mating with the first electrical connector 100. In the illustrated embodiment of the present disclosure, the first electrical connector 100 is a first backplane connector, more specifically, a first backplane cable connector. The second electrical connector 200 is a second backplane connector, more specifically, a second backplane cable connector. The first electrical connector 100 and the second electrical connector 200 are mated along a first direction A1-A1 (i.e., a mating direction) to achieve signal transmission. In the illustrated embodiment of the present disclosure, the first direction A1-A1 is a front-rear direction.

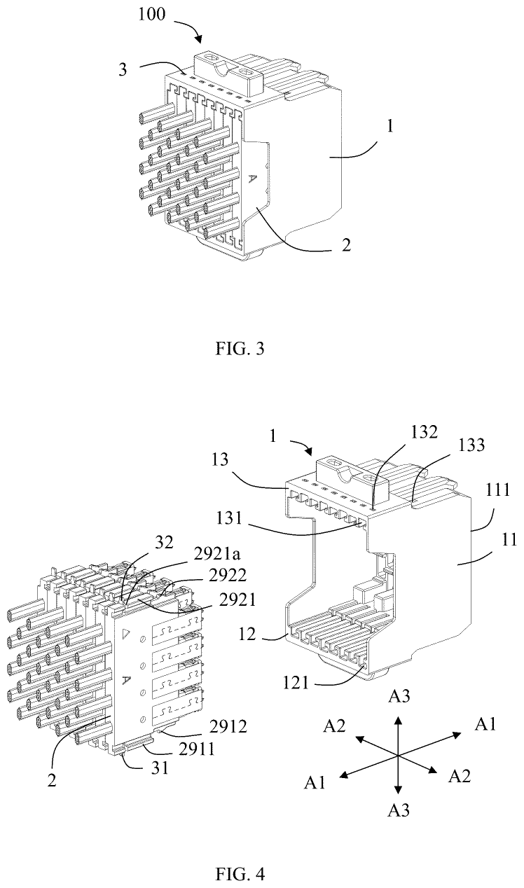

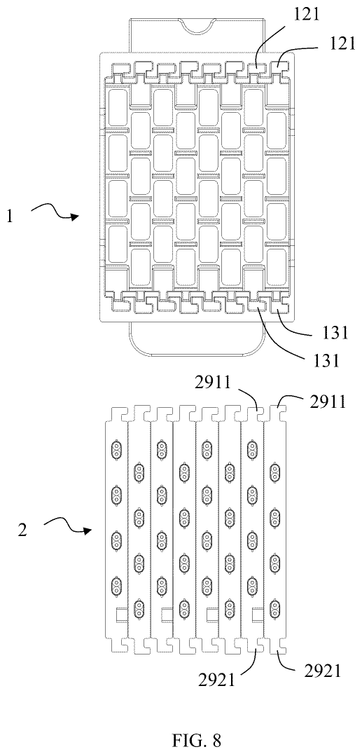

Referring to FIG. 3 to FIG. 8, the first electrical connector 100 includes a first housing 1, a plurality of first mating modules 2 mounted to the first housing 1, and a plurality of first positioning pieces 3 for positioning the first mating modules 2 in the first housing 1. As shown in FIG. 8, it is understandable to those skilled in the art that in the illustrated embodiment of the present disclosure, the plurality of first mating modules 2 are divided into two types and are alternately arranged along a second direction A2-A2. The heights of the two types of first mating modules 2 along a third direction A3-A3 are different. In the illustrated embodiment of the present disclosure, the second direction A2-A2 is a left-right direction. The third direction A3-A3 is a top-bottom direction. Each two of the first direction A1-A1, the second direction A2-A2 and the third direction A3-A3 are perpendicular to each other.

Referring to FIGS. 3 to 6, in the illustrated embodiment of the present disclosure, the first housing 1 is made of insulating material, and includes a first body portion 11, a first wall portion 12 extending backwardly from one end (for example, an upper end) of the first body portion 11, and a second wall portion 13 extending backwardly from the other end (for example, a lower end) of the first body portion 11. The first body portion 11 includes a mating surface 111 and a plurality of first terminal receiving grooves 112 extending through the mating surface 111. In the illustrated embodiment of the present disclosure, the first terminal receiving grooves 112 are disposed in multiple rows along a vertical direction. Two adjacent rows of first terminal receiving grooves 112 are staggered in a left-right direction. That is, the first terminal receiving grooves 112 at corresponding positions in two adjacent rows of the first terminal receiving grooves 112 are not aligned in the left-right direction. The first wall portion 12 includes a plurality of first slots 121, a plurality of first locking slots 122 communicating with the first slots 121, and a plurality of first locking grooves 123 for positioning the corresponding first mating modules 2. In the illustrated embodiment of the present disclosure, the first locking grooves 123 communicate with corresponding first slots 121, and the first locking grooves 123 extend through the first wall portion 12 along the top-bottom direction. The second wall portion 13 includes a plurality of second slots 131, a plurality of second locking slot 132 communicating with the second slots 131, and a plurality of second locking grooves 133 for positioning the corresponding first mating modules 2. In the illustrated embodiment of the present disclosure, the second locking grooves 133 communicate with corresponding second slots 131, and the second locking grooves 133 extend through the second wall portion 13 in top-bottom direction. The first slots 121 and the second slots 131 extend in the front-rear direction. The first slot 121 and the second slot 131 which are in alignment with each other in the vertical direction are used for receiving one first mating module 2. The first locking slots 122 and the second locking slots 132 extend along the vertical direction. The first locking slots 122 extend through the first wall portion 12 along the vertical direction so as to communicate with the corresponding first slots 121. The second locking slots 132 extend through the second wall portion 13 along the vertical direction so as to communicate with the corresponding second slots 131.

In the illustrated embodiment of the present disclosure, each of the first slots 121 and the second slots 131 is L-shaped, but the positions and/or sizes of two adjacent first slots 121 in the left-right direction are different. The positions and/or sizes of two adjacent second slots 131 along the left-right direction are different. With this arrangement, the first mating module 2 of the present disclosure can be prevented from being inserted into a non-corresponding first slot 121 and a non-corresponding second slot 131.

Referring to FIG. 8, it is understandable to those skilled in the art that in the illustrated embodiment of the present disclosure, the positions of the two adjacent first slots 121 in the left-right direction are different, in which the position of one of the two adjacent first slots 121 is higher than the position of a remaining one of the two adjacent first slots 121. The positions of the two adjacent second slots 131 in the left-right direction are also different. The position of one of the two adjacent second slots 131 is lower than the position of a remaining one of the two adjacent second slots 131. With this arrangement, the first slot 121 and the second slot 131 that jointly accommodate the first mating module 2 have a first height along the top-bottom direction; another first slot 121 and another second slot 131 that jointly receive another adjacent first mating module 2 have a second height along the top-bottom direction; wherein the first height is different from the second height.

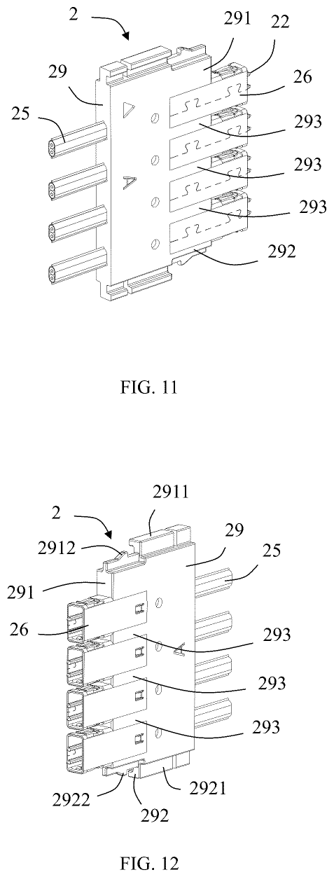

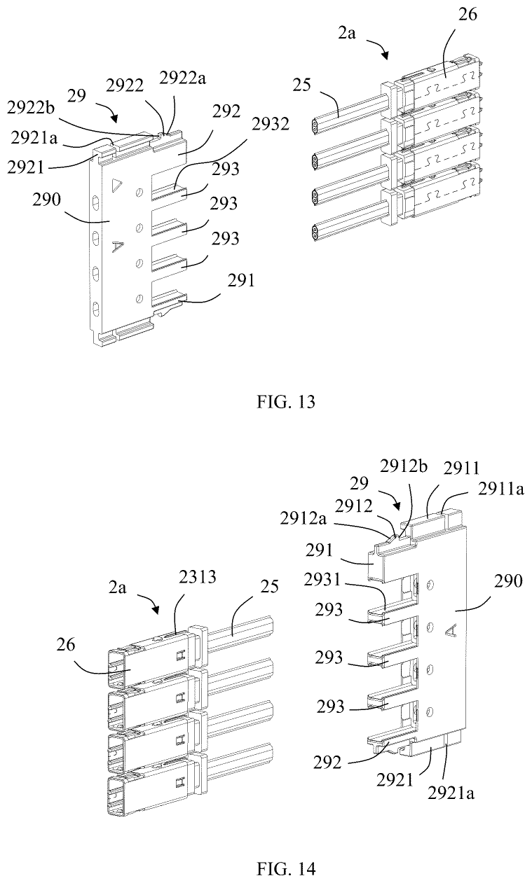

Referring to FIG. 11 to FIG. 14, each first mating module 2 includes a plurality of first cable modules 2a spaced apart in the top-bottom direction and a first fixing block 29 fixed on the plurality of first cable modules 2a. In one embodiment of the present disclosure, the first fixing block 29 is made of insulating material. The first fixing block 29 is over-molded on the plurality of first cable modules 2a so as to be integrated with the plurality of first cable modules 2a as a whole. In the illustrated embodiment of the present disclosure, the first fixing block 29 is embedded in the groove of the first cable module 2a during the over-molding process so as to increase the bonding force therebetween. Of course, it is understandable to those skilled in the art that the plurality of first cable modules 2a can also be fixed on the first fixing block 29 through assembling or other methods, which will not be described in the present disclosure.

Referring to FIG. 11 to FIG. 14, the first fixing block 29 includes a first base 290, a first extending block 291 protruding forwardly from a top of the first base 290, a second extending block 292 protruding forwardly from a bottom of the first base 290, and a plurality of first support blocks 293 protruding forwardly from a middle portion of the first base 290. The first extending block 291 includes a first positioning block 2911 and a first locking protrusion 2912 located at a front end of the first positioning block 2911. In the illustrated embodiment of the present disclosure, the first positioning block 2911 is L-shaped. The first positioning block 2911 is configured to be received in a corresponding first slot 121. The first positioning block 2911 further defines a first notch 2911a that communicates with the corresponding first locking slot 122 in the top-bottom direction. The first locking protrusion 2912 is configured to be locked in a corresponding first locking groove 123. In the illustrated embodiment of the present disclosure, the first locking protrusion 2912 includes a first guide inclined surface 2912a and a first locking surface 2912b located at a rear end of the first guide inclined surface 2912a. The first locking surface 2912b is configured to abut against the first wall portion 12 so as to prevent the first mating module 2 from being separated from the first wall portion 12.

Similarly, the second extending block 292 includes a second positioning block 2921 and a second locking protrusion 2922 located at a front end of the second positioning block 2921. In the illustrated embodiment of the present disclosure, the second positioning block 2921 is L-shaped. The second positioning block 2921 is configured to be received in a corresponding second slot 131. The second positioning block 2921 further defines a second notch 2921a that communicates with the corresponding second locking slot 132 in the top-bottom direction. The second locking protrusion 2922 is configured to be locked in a corresponding second locking groove 133. In the illustrated embodiment of the present disclosure, the second locking protrusion 2922 includes a second guide inclined surface 2922a and a second locking surface 2922b located at a rear end of the second guide inclined surface 2922a. The first guide inclined surface 2912a and the second guide inclined surface 2922a are configured to guide the first mating module 2 to be inserted into the corresponding first slot 121 and the corresponding second slot 131. The second locking surface 2922b is configured to abut against the second wall portion 13 so as to prevent the first mating module 2 from being separated from the second wall portion 13.

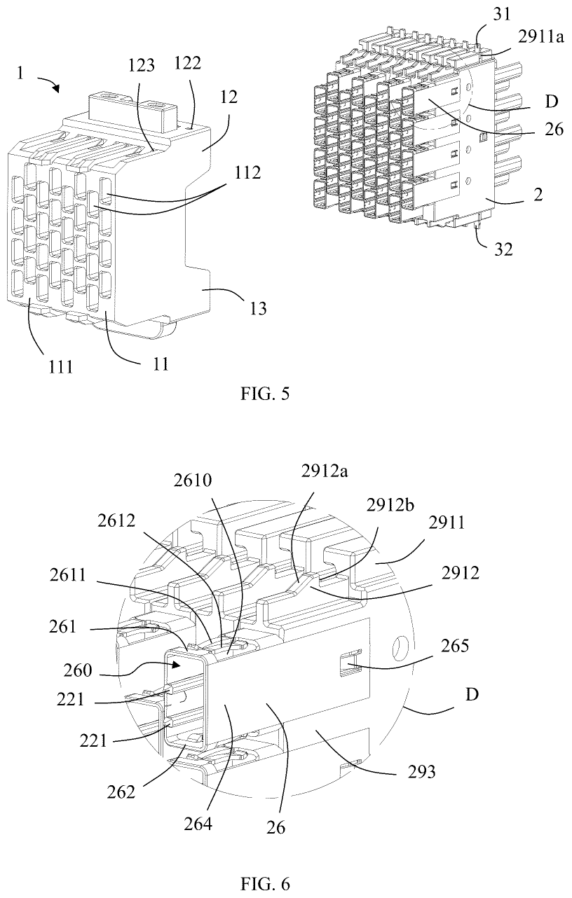

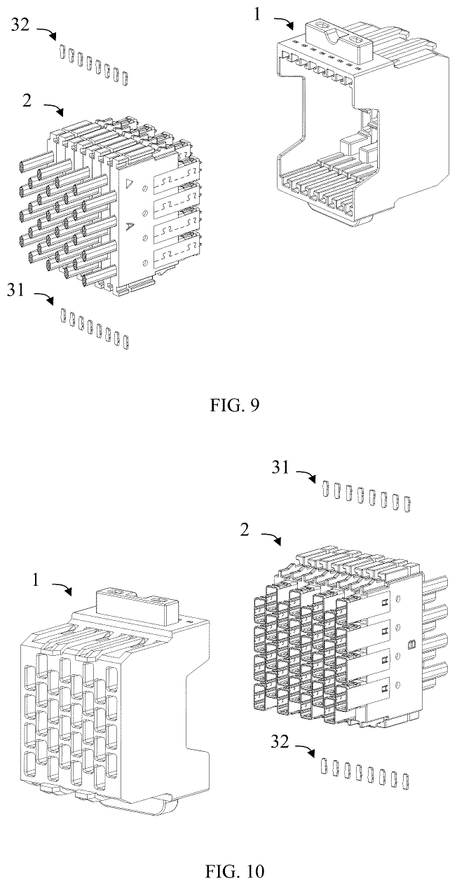

Referring to FIG. 4, FIG. 5, FIG. 9 and FIG. 10, in the embodiment of the present disclosure, the first positioning pieces 3 include a plurality of first pin pieces 31 and a plurality of second pin pieces 32. The first pin pieces 31 and the second pin pieces 32 are both stamped from metal sheets. In an embodiment of the present disclosure, the plurality of first pin pieces 31 can be provided separately and installed in the corresponding first locking slots 122 and the first notches 2911a respectively. The plurality of second pin pieces 32 can be provided separately and installed in the corresponding second locking slots 132 and the second notches 2921a respectively. Of course, in other embodiments of the present disclosure, the plurality of first pin pieces 31 can also be connected as a whole through a first material strip (not shown). The plurality of second pin pieces 32 can also be connected as a whole through a second material strip (not shown). During assembling, the first pin pieces 31 and the second pin pieces 32 are integrally installed in the corresponding first locking slots 122 and the first notches 2911a, and the second locking slots 132 and the second notches 2921a, respectively, to improve installation efficiency. After the assembly is completed, the first material strip and the second material strip can be removed or retained according to actual needs. By having the first pin pieces 31 and the second pin pieces 32 to fix the first mating modules 2, the first mating modules 2 can be prevented from being detached from the first housing 1 in a direction opposite to its assembly direction. Besides, this design saves spaces because the first pin pieces 31 and the second pin pieces 32 can be hidden in the first housing 1. Therefore, the size of the first electrical connector 100 is reduced to a certain extent, and the probability that the first pin pieces 31 and the second pin pieces 32 lose their limiting function due to improper external forces is reduced.

As shown in FIG. 11 to FIG. 14, each two adjacent first cable modules 2a in the top-bottom direction is associated with one first support block 293 located therebetween so as to better support and protect the first cable modules 2a. In the illustrated embodiment of the present disclosure, each first support block 293 defines a first recessed portion 2931 and a second recessed portion 2932 opposite to the first recessed portion 2931. The first recessed portion 2931 and the second recessed portion 2932 are respectively adapted to corresponding side surfaces of the corresponding first cable module 2a.

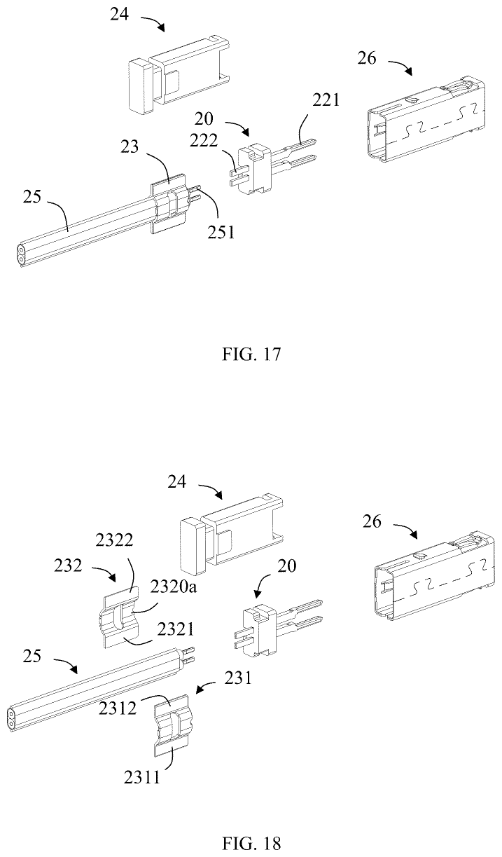

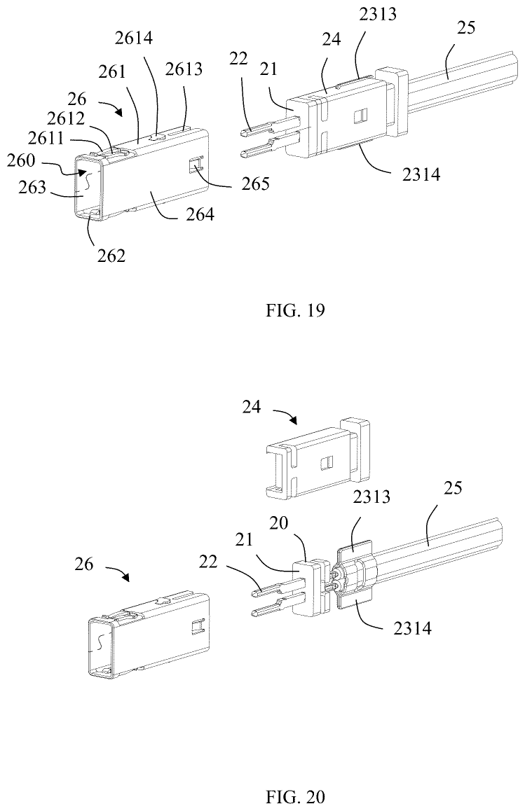

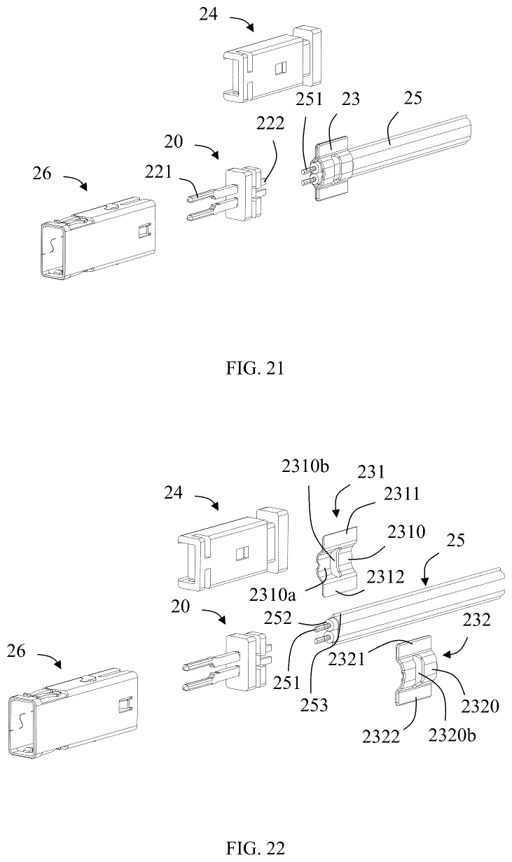

Referring to FIG. 11 to FIG. 22, in the illustrated embodiment of the present disclosure, each first cable module 2a includes a first terminal module 20, a plurality of first cables 25 connected to the first terminal module 20, a first shielding clamping plate 23 mating with the first cables 25, a first covering block 24 at least partially fixed on the first terminal module 20, the first shielding clamping plate 23 and the first cables 25, and a metal shielding sleeve 26 at least partially sleeved on the first terminal module 20.

In the illustrated embodiment of the present disclosure, the first terminal module 20 includes a holding block 21 and a plurality of first conductive terminals 22 fixed to the holding block 21. In an embodiment of the present disclosure, the holding block 21 is made of insulating material. The first conductive terminals 22 are insert-molded with the holding block 21. Of course, in other embodiments, the first conductive terminals 22 can also be fixed to the holding block 21 through assembling. In the illustrated embodiment of the disclosure, the holding block 21 includes a first recess 210 which extends along a circumferential direction of the holding block 21.

Each group of first conductive terminals 22 includes a first contact portion 221, a first tail portion 222, and a first connecting portion 223 connecting the first contact portion 221 and the first tail portion 222. The first connecting portion 223 is fixed to the holding block 21. The first contact portion 221 is of a needle-shaped configuration and protrudes forwardly beyond the holding block 21 to mate with the second electrical connector 200. The first tail portion 222 extends backwardly beyond the holding block 21 to be electrically connected to the first cable 25. In the illustrated embodiment of the present disclosure, the first conductive terminal 22 is substantially straight and extends in the front-rear direction. The first contact portion 221 protrudes forwardly beyond the metal shielding sleeve 26.

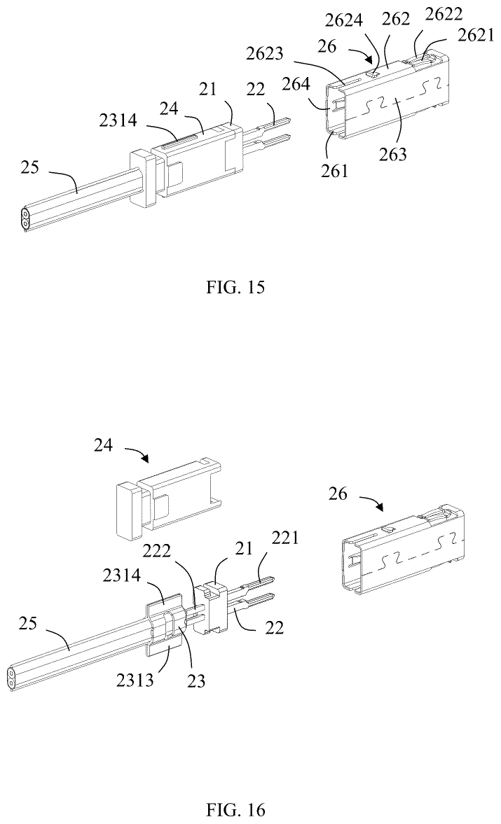

In one embodiment of the present disclosure, the first conductive terminals 22 in each first terminal module 20 form a first signal differential pair to increase the signal transmission rate. Referring to FIGS. 15 to 22, the first cable 25 includes a first core 251 for electrically connecting with the first tail portion 222 of the first signal differential pair, a first insulating layer 252 wrapped around the first core 251, and a first ground wire 253. In an embodiment of the present disclosure, the first core 251 and the first tail portion 222 of the first signal differential pair are fixed by soldering or welding. In the illustrated embodiment of the present disclosure, the first ground wire 253 is in contact with the first shielding clamping plate 23.

In the illustrated embodiment of the present disclosure, the first shielding clamping plate 23 is made of metal material. The first shielding clamping plate 23 includes a first clamping plate portion 231 and a second clamping plate portion 232. The first clamping plate portion 231 and the second clamping plate portion 232 are clamped and fixed on the first cables 25. The first clamping plate portion 231 and the second clamping plate portion 232 are both in contact with the first ground wire 253. In the illustrated embodiment of the disclosure, the first ground wire 253 is clamped between the first clamping plate portion 231 and the second clamping plate portion 232.

Of course, it is understandable to those skilled in the art that the first cable 25 can be a single ground wire cable, a double ground wire cable or a non-ground wire cable in the prior art. When the first cable 25 adopts the single ground wire cable or the double ground wire cable, the ground wire is in contact with the first shielding clamping plate 23 to achieve the ground conduction. When the first cable 25 adopts the non-ground wire cable, the first cable 25 is provided with a shielding layer which is in contact with the first shielding clamping plate 23 to achieve the ground conduction.

In the illustrated embodiment of the present disclosure, the first clamping plate portion 231 includes a first clamping portion 2310, a first tab portion 2311 extending from a top end of the first clamping portion 2310, and a second tab portion 2312 extending from a bottom end of the first clamping portion 2310. The first clamping portion 2310 has an arc-shaped first inner surface 2310a and a first opening 2310b extending through the first clamping portion 2310.

The second clamping plate portion 232 includes a second clamping portion 2320, a third tab portion 2321 extending from a top end of the second clamping portion 2320, and a fourth tab portion 2322 extending from a bottom end of the second clamping portion 2320.

The second clamping portion 2320 has an arc-shaped second inner surface 2320a and a second opening 2320b extending through the second clamping portion 2320.

The first clamping portion 2310 and the second clamping portion 2320 jointly clamp the first cable 25. The first opening 2310b and the second opening 2320b are configured to be filled with solder, so that the first shielding clamping plate 23 and the first ground wire 253 can be easily soldered.

In the illustrated embodiment of the present disclosure, the first tab portion 2311 and the third tab portion 2321 are abutted together to form a first insertion tab 2313. The second tab portion 2312 and the fourth tab portion 2322 are abutted together to form a second insertion tab 2314. The first insertion tab 2313 and the second insertion tab 2314 are both in contact with the metal shielding sleeve 26.

In one embodiment of the present disclosure, the first covering block 24 is over-molded on the first terminal module 20, the first shielding clamping plate 23 and the first cable 25 so as to be integrated with the first terminal module 20, the first shielding clamping plate 23 and the first cable 25 as a whole. Specifically, the first covering block 24 is embedded in the first recess 210 of the holding block 21 to improve the bonding reliability thereof. The first insertion tab 2313 and the second insertion tab 2314 protrude beyond the first covering block 24, respectively.

In the illustrated embodiment of the present disclosure, the metal shielding sleeve 26 is generally in a shape of a cuboid, which includes a first side wall 261 (for example, a top wall), a second side wall 262 (for example, a bottom wall) opposite to the first side wall 261, a third side wall 263 (for example, a left side wall) connecting one end of the first side wall 261 and one end of the second side wall 262, and a fourth side wall 264 (for example, a right side wall) connecting another end of the first side wall 261 and another end of the second side wall 262. In the illustrated embodiment of the present disclosure, the metal shielding sleeve 26 is an integrated structure formed by bending a metal plate. That is, the first side wall 261, the fourth side wall 264, the second side wall 262 and the third side wall 263 are connected in sequence. In the illustrated embodiment of the present disclosure, the metal shielding sleeve 26 is made of a metal plate formed by stamping. The third side wall 263 is provided with dovetail bumps and dovetail grooves that are interlocked with each other. The metal shielding sleeve 26 includes a shielding cavity 260 enclosed by the first side wall 261, the fourth side wall 264, the second side wall 262 and the third side wall 263.

In the illustrated embodiment of the present disclosure, the first side wall 261 and the second side wall 262 are located on short sides of the cuboid. The third side wall 263 and the fourth side wall 264 are located on long sides of the cuboid. The first side wall 261 includes a hollow portion 2610, a first contact elastic arm 2611 extending into the hollow portion 2610 along a back-to-front direction, and a second contact elastic arm 2612 extending into the hollow portion 2610 along a front-to-rear direction. In other words, the first contact elastic arm 2611 and the second contact elastic arm 2612 extend into the hollow portion 2610 along opposite directions. The first contact elastic arm 2611 and the second contact elastic arm 2612 are cantilever-shaped and are spaced apart along the left-right direction. In the illustrated embodiment of the present disclosure, the first contact elastic arm 2611 and the second contact elastic arm 2612 are both inclined at a certain angle in the front-rear direction. An end of the first contact elastic arm 2611 and an end of the second contact elastic arm 2612 at least partially protrude into the shielding cavity 260 to abut against the second electrical connector 200. By providing the above first contact elastic arm 2611 and the second contact elastic arm 2612, the integrity of signal transmission can be improved and resonance can be eliminated.

Similarly, the second side wall 262 includes a third contact elastic arm 2621 extending from the rear-to-front direction and a fourth contact elastic arm 2622 extending from the front-to-rear direction. The third contact elastic arm 2621 and the fourth contact elastic arm 2622 are disposed along the left-right direction. In the illustrated embodiment of the present disclosure, the third contact elastic arm 2621 and the fourth contact elastic arm 2622 are both inclined in the front-rear direction. The third contact elastic arm 2621 and the fourth contact elastic arm 2622 both at least partially protrude into the shielding cavity 260. By providing the above third contact elastic arm 2621 and the fourth contact elastic arm 2622, the integrity of signal transmission can be improved and resonance can be eliminated.

The third side wall 263 and/or the fourth side wall 264 are each provided with a retaining tab 265 protruding inwardly into the shielding cavity 260. The retaining tab 265 is locked with the first covering block 24 to increase the holding force.

Besides, the first side wall 261 further includes a first slot 2613 and a first protruding tab 2614 located at a front end of the first slot 2613. The first protruding tab 2614 is configured to increase the bonding force with the first fixing block 29. The second side wall 262 further includes a second slot 2623 and a second protruding tab 2624 located at a front end of the second slot 2623. The second protruding tab 2624 is configured to increase the bonding force with the first fixing block 29.

In the illustrated embodiment of the present disclosure, the first slot 2613 is configured for inserting the first insertion tab 2313. The second slot 2623 is configured for inserting the second insertion tab 2314. Preferably, the first insertion tab 2313 is fixed to the first side wall 261 by soldering or welding after being inserted into the first slot 2613. The second insertion tab 2314 is fixed to the second side wall 262 by soldering or welding after being inserted into the second slot 2623.

It is understandable to those skilled in the art that in the illustrated embodiment of the present disclosure, the first ground wire 253 is in contact with the first shielding clamping plate 23, and the first shielding clamping plate 23 is in contact with the metal shielding sleeve 26. With this arrangement, the first ground wire 253, the first shielding clamping plate 23 and the metal shielding sleeve 26 form a ground shielding structure connected in series, thereby improving the quality of signal transmission.

During assembling, the first tail portion 222 of the first conductive terminal 22 is in contact with the first cable 25, for example, by soldering or welding. Then, the first shielding clamping plate 23 is clamped and fixed to the first cable 25 so that the first shielding clamping plate 23 is in contact with the first ground wire 253, for example, by soldering or welding. Then, the first covering block 24 is over-molded on the holding block 21, the first shielding clamping plate 23 and the first ground wire 253 to be integrated as a sub-assembly. Then, the sub-assembly is then assembled with the metal shielding sleeve 26. For example, the sub-assembly is inserted into the metal shielding sleeve 26. The first contact portion 221 of the first conductive terminal 22 is at least partially located in the shielding cavity 260 in a suspended manner. In the illustrated embodiment of the present disclosure, the end of the first contact portion 221 slightly extends forwardly and protrudes beyond the metal shielding sleeve 26. Then, the formed plurality of first cable modules 2a are fixed to the first fixing block 29. For example, the first fixing block 29 is over-molded on the plurality of first cable modules 2a. At this time, each first support block 293 is tightly clamped between two adjacent metal shielding sleeves 26 in the top-bottom direction. The first recessed portion 2931 of the first support block 293 is in contact with the second side wall 262 of the metal shielding sleeve 26 located above the second side wall 262. The second recessed portion 2932 of the first support block 293 is in contact with the first side wall 261 of the metal shielding sleeve 26 located below the first side wall 261.

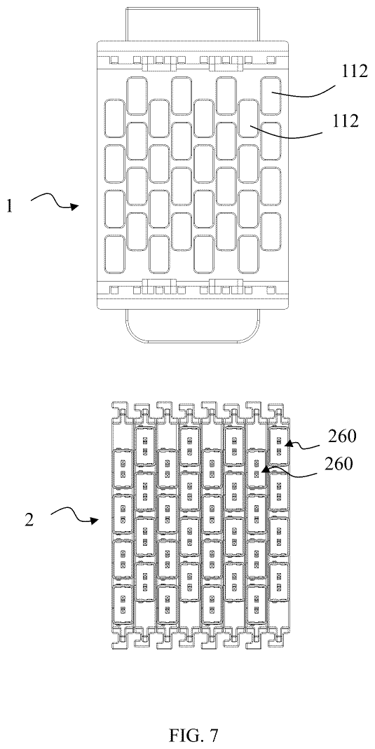

In the illustrated embodiment of the present disclosure, a plurality of first mating modules 2 are provided on the first electrical connector 100, and the terminal arrangements of two adjacent first mating modules 2 are disposed in a staggered manner. Correspondingly, the shielding cavities 260 at the same position of the two adjacent first mating modules 2 are disposed in a staggered manner (see FIG. 7).

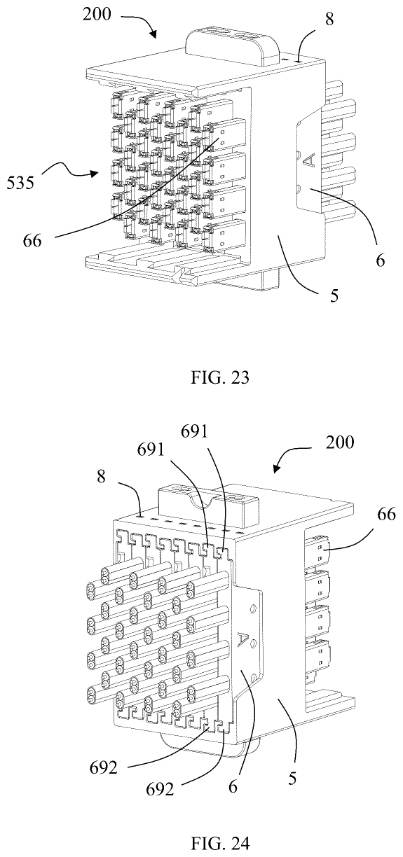

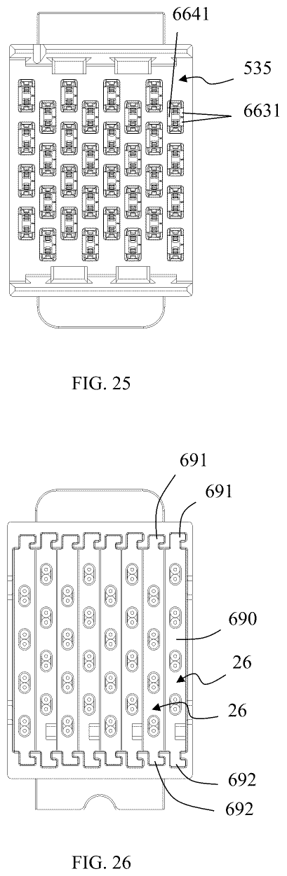

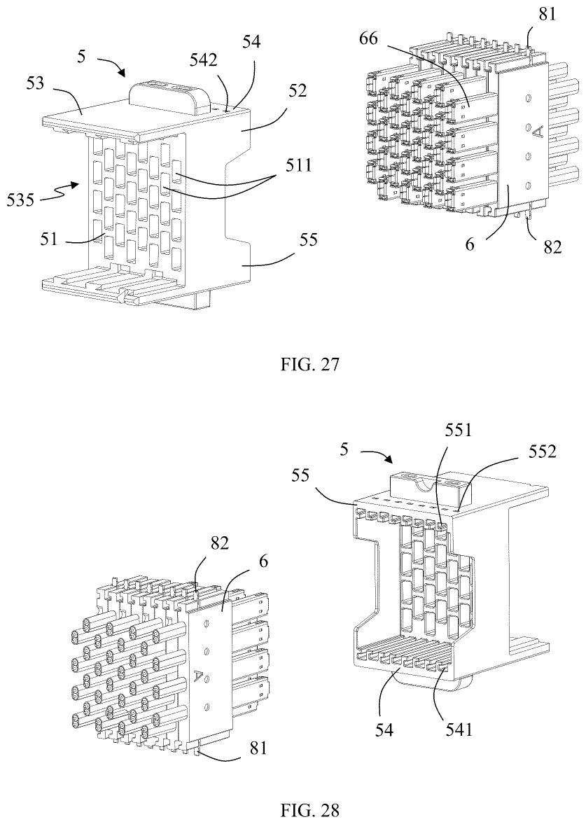

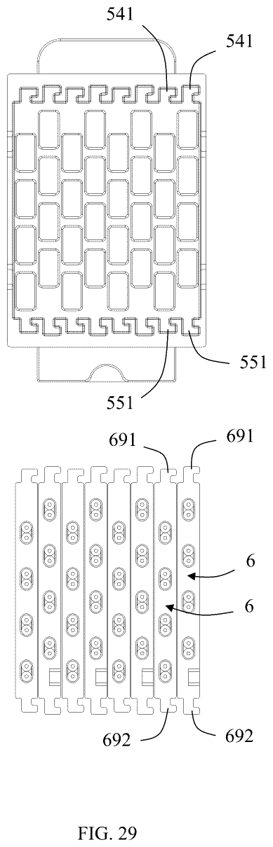

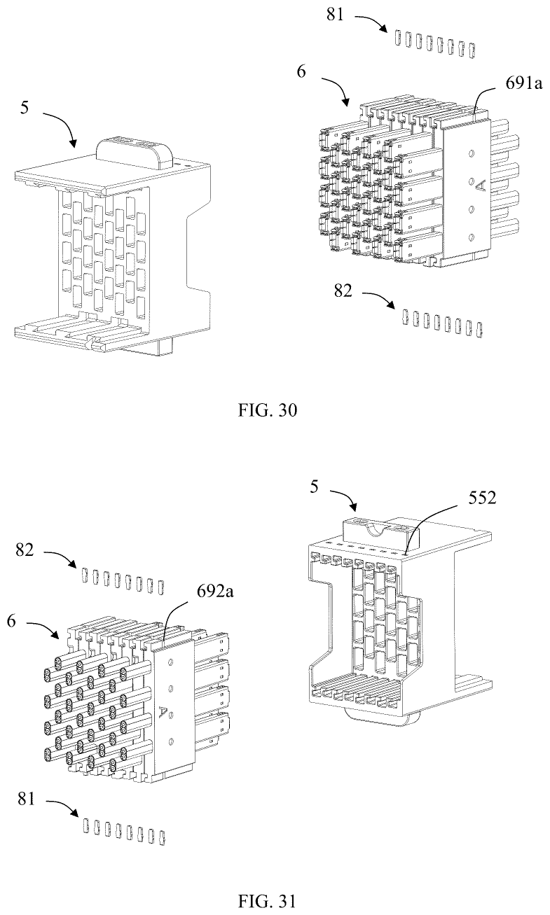

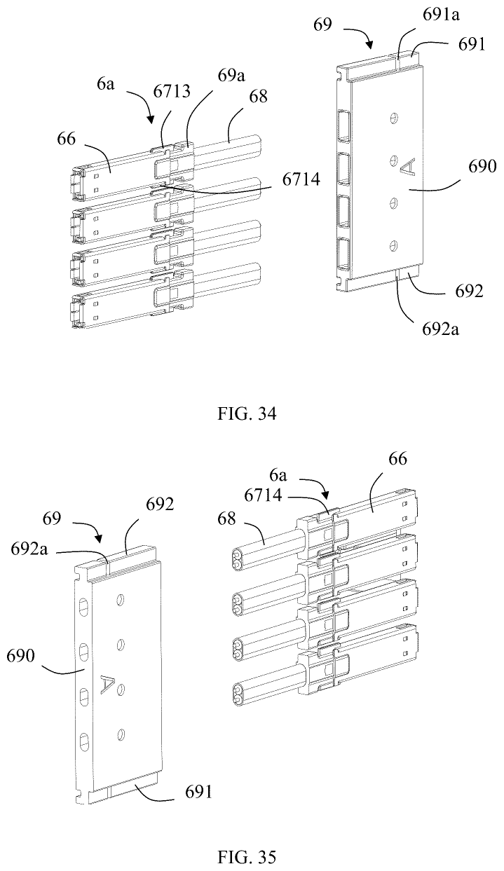

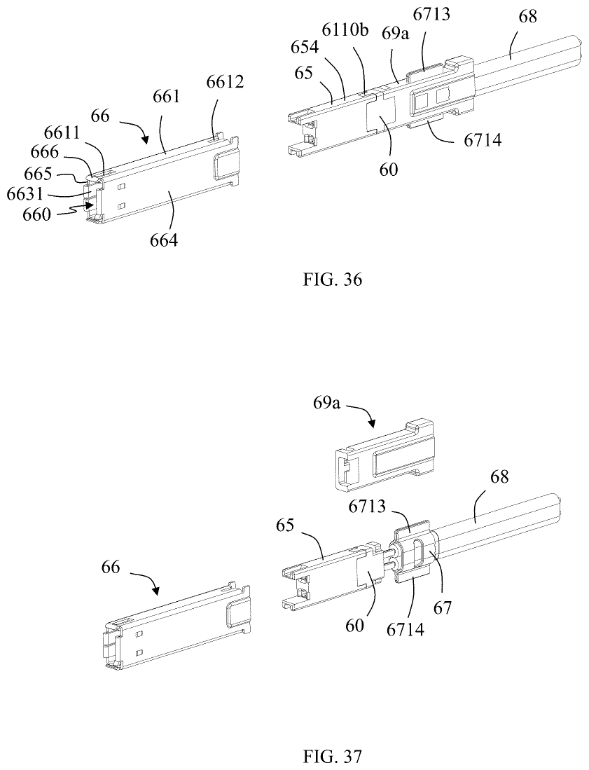

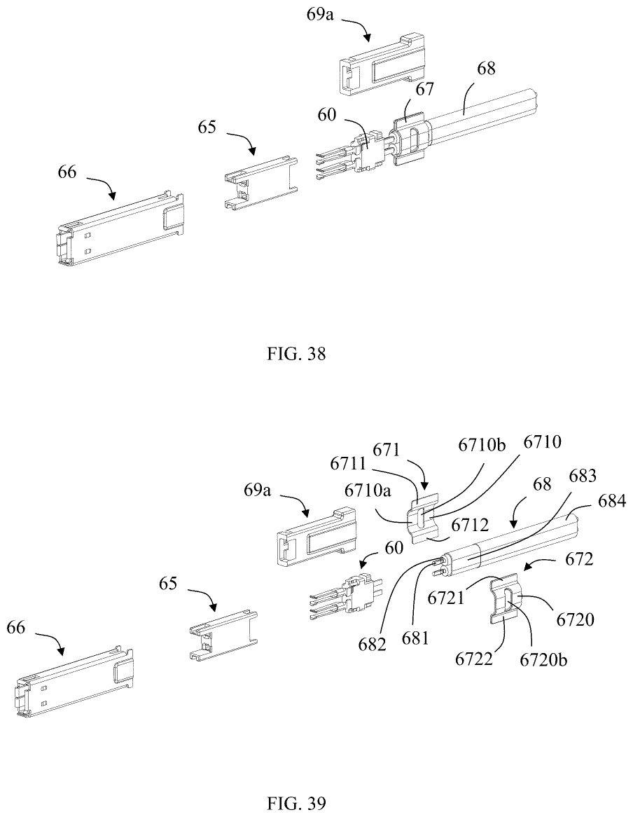

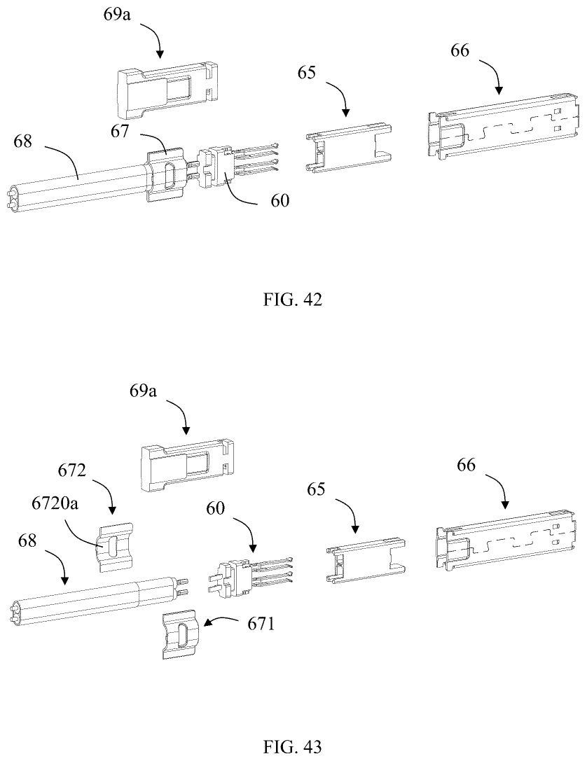

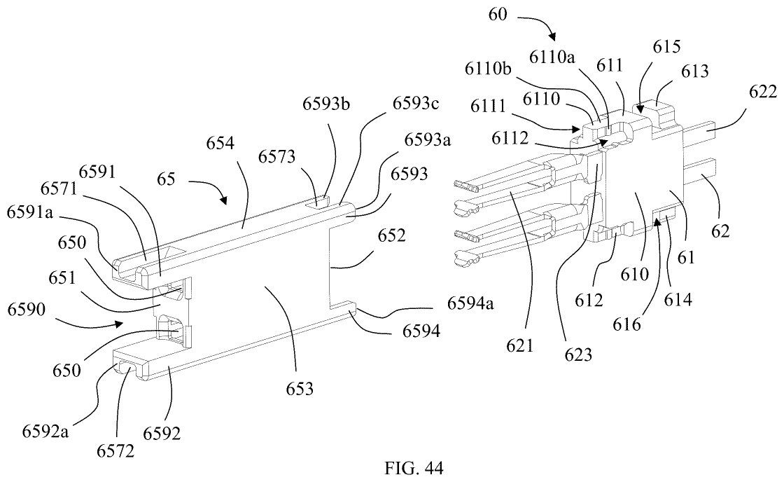

Referring to FIG. 23 to FIG. 45, the second electrical connector 200 includes a second housing 5, a plurality of second mating modules 6 mounted to the second housing 5, and a plurality of second positioning pieces 8 for positioning the second mating modules 6 in the second housing 5. Referring to FIG. 26, it is understandable to those skilled in the art that in the illustrated embodiment of the present disclosure, the plurality of second mating modules 6 are divided into two types and are alternately arranged in the left-right direction. The two types of second mating modules 6 have different heights in the top-bottom direction.

The second housing 5 is made of insulating material and includes a second body portion 51, a first extension wall portion 52 extending from the second body portion 51 to one end, a second extension wall portion 53 extending from the second body portion 51 to another end. The second body portion 51 defines a plurality of second terminal receiving grooves 511 extending along the front-rear direction. In the illustrated embodiment of the disclosure, the second terminal receiving grooves 511 are disposed in multiple rows along the left-right direction. Two adjacent rows of second terminal receiving grooves 511 are staggered in the top-bottom direction. That is, the second terminal receiving grooves 511 at corresponding positions in two adjacent rows of second terminal receiving grooves 511 are not aligned in the left-right direction. The first extension wall portion 52 includes a first extension wall portion 54 and a second extension wall portion 55 that are disposed oppositely. The second extension wall portion 53 defines a receiving space 535 configured to at least partially accommodate the first electrical connector 100. The first extension wall portion 54 defines a plurality of third slots 541 and a plurality of third locking slots 542 communicating with the third slots 541. The second extension wall portion 55 defines a plurality of fourth slots 551 and a plurality of fourth locking slots 552 communicating with the fourth slots 551. The third slots 541 and the fourth slots 551 extend in the front-rear direction. The third slots 541 and the fourth slots 551 which are aligned with each other in the top-bottom direction are configured to receive a corresponding second mating module 6. The third locking slots 542 and the fourth locking slots 552 extend in the top-bottom direction. The third locking slots 542 extend through the first extension wall portion 54 along the top-bottom direction to communicate with the corresponding third slots 541. The fourth locking slots 552 extend through the second extension wall portion 55 along the top-bottom direction to communicate with the corresponding fourth slots 551.

In the illustrated embodiment of the present disclosure, each of the third slots 541 and the fourth slot 551 is L-shaped. The positions and/or sizes of two adjacent third slots 541 along the left-right direction are different. The positions and/or sizes of two adjacent fourth slots 551 along the left-right direction are different. With this arrangement, the second mating module 6 of the present disclosure can be prevented from being inserted into a non-corresponding third slot 541 and a non-corresponding fourth slot 551.

It is understandable to those skilled in the art that in the illustrated embodiment of the present disclosure, the positions of the two adjacent third slots 541 in the left-right direction are different. The position of one of the two adjacent third slots 541 is higher than the position of a remaining one of the two adjacent third slots 541. The positions of the two adjacent fourth slots 551 in the left-right direction are also different. The position of one of the two adjacent fourth slots 551 is lower than the position of a remaining one of the two adjacent fourth slots 551. With this arrangement, the third slot 541 and the fourth slot 551 that jointly accommodate one second mating module 6 have a third height along the top-bottom direction; another third slot 541 and another fourth slot 551 that jointly accommodate another adjacent second mating module 6 have a fourth height along the top-bottom direction; wherein the third height is different from the fourth height.

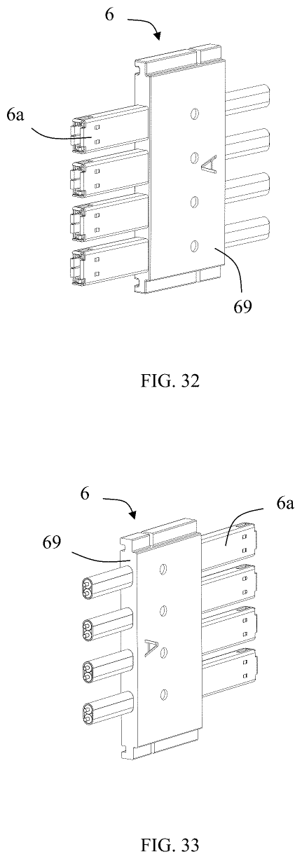

Referring to FIG. 32 to FIG. 43, the second mating module 6 includes a plurality of second cable modules 6a spaced apart in the top-bottom direction and a second fixing block 69 fixing on the plurality of second cable modules 6a. In one embodiment of the present disclosure, the second fixing block 69 is made of insulating material, and is over-molded on the plurality of second cable modules 6a to be integrated with the plurality of second cable modules 6a as a whole. In the illustrated embodiment of the present disclosure, the second fixing block 69 is embedded in the groove of the second cable module 6a during the insert-molding process to increase the bonding force therebetween. Of course, it is understandable to those skilled in the art that the plurality of second cable modules 6a can also be fixed to the second fixing block 69 through assembling or other methods, which will not be described in the present disclosure.

The second fixing block 69 includes a second base 690, a third positioning block 691 protruding upwardly from a top of the second base 690, and a fourth positioning block 692 protruding downwardly from a bottom of the second base 690. In the illustrated embodiment of the present disclosure, the third positioning block 691 is L-shaped. The third positioning block 691 is configured to be received in the third slot 541. The third positioning block 691 further defines a third notch 691a that communicates with a corresponding third locking slot 542 in the top-bottom direction. Similarly, the fourth positioning block 692 is L-shaped. The fourth positioning block 692 is configured to be received in the fourth slot 551. The fourth positioning block 692 further defines a fourth notch 692a that communicates with a corresponding fourth locking slot 552 in the top-bottom direction.

In one embodiment of the present disclosure, the second positioning pieces 8 includes a plurality of third pin pieces 81 and a plurality of fourth pin pieces 82. The third pin pieces 81 and the fourth pin pieces 82 are both stamped from metal sheets. The plurality of third pin pieces 81 can be provided individually and installed in corresponding third locking slots 542 and third notches 691a respectively. The plurality of fourth pin pieces 82 can be provided individually and installed in corresponding fourth locking slots 552 and fourth notches 692a respectively. Of course, in other embodiments, the plurality of third pin pieces 81 can also be connected as a whole through a third material strip (not shown), and the plurality of fourth pin pieces 82 can also be connected as a whole through a fourth material strip (not shown). During assembling, the third pin pieces 81 and the fourth pin pieces 82 are integrally installed in the corresponding third locking slots 542 and the third notches 691a, and the fourth locking slots 552 and the fourth notches 692a, respectively, to improve installation efficiency. After the assembly is completed, the third material strip and the fourth material strip can be removed or retained according to actual needs. By providing the third pin pieces 81 and the fourth pin pieces 82 to fix the second mating modules 6, it is possible to prevent the second mating modules 6 from being separated from the second housing 5 in a direction opposite to its assembly direction. Besides, this design saves spaces because the third pin pieces 81 and the fourth pin pieces 82 can be hidden in the second housing 5. The size of the second electrical connector 200 is reduced to a certain extent, and the probability that the third pin pieces 81 and the fourth pin pieces 82 lose their limiting function due to improper external forces is reduced.

Each second cable module 6a includes an insulating block 65, a second terminal module 60 mounted to the insulating block 65, a second cable 68 electrically connected to the second terminal module 60, a second shielding clamping plate 67 clamping the second cable 68, a second covering block 69a at least partially fixed on the second terminal module 60, the second shielding clamping plate 67 and the second cable 68, and a metal shield surrounding member 66 is at least partially sleeved on the insulating block 65, the second terminal module 60 and the second covering block 69a.

In the illustrated embodiment of the present disclosure, the second covering block 69a is over-molded on the insulating block 65, the second terminal module 60, the second shielding clamping plate 67 and the second cable 68 to be integrated as a whole.

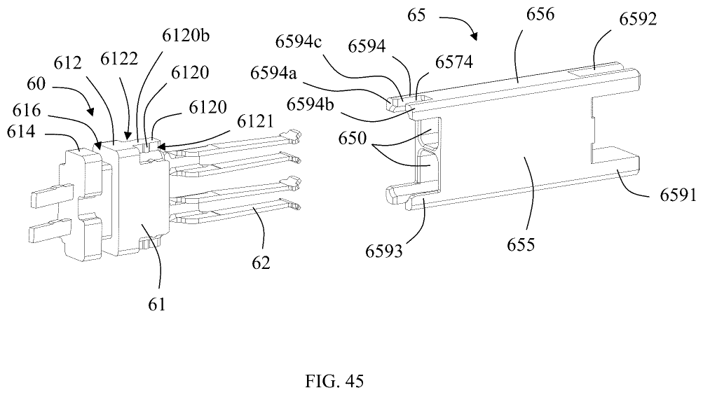

Referring to FIG. 45, the second terminal module 60 includes an insulative block 61 and a plurality of second conductive terminals 62 fixed to the insulative block 61. In one embodiment of the present disclosure, the second conductive terminals 62 are insert-molded with the insulative block 61. Of course, in other embodiments, the second conductive terminals 62 can also be fixed to the insulative block 61 through assembling.

In the illustrated embodiment of the present disclosure, the insulative block 61 includes a base portion 610, a first bump portion 611 protruding upwardly from the base portion 610, a second bump portion 612 protruding downwardly from the base portion 610, a first protruding strip portion 613 protruding upwardly from the base portion 610 and located at a rear end of the first bump portion 611, a second protruding strip portion 614 protruding downwardly from the base portion 610 and located at a rear end of the second bump portion 612, a first recessed groove 615 located between the first bump portion 611 and the first protruding strip portion 613 along the front-rear direction, and a second recessed groove 616 located between the second bump portion 612 and the second protruding strip portion 614 along the front-rear direction. The second covering block 69a is embedded in the first recessed groove 615 and the second recessed groove 616 to increase the bonding force.

In the illustrated embodiment of the present disclosure, the first bump portion 611 is generally T-shaped and includes a first inserting block 6110, a first opening 6111 located on one side of the first inserting block 6110, and a second opening 6112 located on another side of the first inserting block 6110.

Similarly, the second bump portion 612 is generally T-shaped and includes a second inserting block 6120, a third opening 6121 located on one side of the second inserting block 6120, and a fourth opening 6122 located on another side of the second inserting block 6120.

Each group of second conductive terminals 62 includes a second contact arm 621, a second tail portion 622, and a second connecting portion 623 connecting the second contact arm 621 and the second tail portion 622. The second connecting portion 623 is fixed to the insulative block 61. The second contact arm 621 extends forwardly and protrudes beyond the insulative block 61 to be electrically connected to the first electrical connector 100. The second tail portion 622 extends backwardly and protrudes beyond the insulative block 61 to be electrically connected to the second cable 68. In the illustrated embodiment of the present disclosure, the second conductive terminal 62 is substantially straight and extends in the front-rear direction.

In one embodiment of the present disclosure, the second conductive terminals 62 in each second terminal module 60 form a pair of second signal differential pair to increase the signal transmission rate.

Each insulating block 65 includes a first end surface 651, a second end surface 652 opposite to the first end surface 651, at least one terminal receiving hole 650 extending through the first end surface 651 and the second end surface 652, a first extension block 6591 protruding from the first end surface 651 and located on one side of the insulating block 65, a second extension block 6592 protruding from the first end surface 651 and located on another side of the insulating block 65, a third extension block 6593 protruding from the second end surface 652 and located on the one side of the insulating block 65, and a fourth extension block 6594 protruding from the second end surface 652 and located on the another side of the insulating block 65. The insulating block 65 further includes an accommodating space 6590 located between the first extension block 6591 and the second extension block 6592. The first extension block 6591 is provided with a first mating surface 6591a. The second extension block 6592 is provided with a second mating surface 6592a. The third extension block 6593 is provided with a third mating surface 6593a. The fourth extension block 6594 is provided with a fourth mating surface 6594a. In the illustrated embodiment of the present disclosure, the insulating block 65 is generally in a shape of cuboid, and includes a first side 653, a second side 654, a third side 655 and a fourth side 656 connected in sequence. The first side 653 is opposite to the third side 655. The second side 654 is opposite to the fourth side 656. The first extension block 6591 and the second extension block 6592 are provided on the second side 654 and the fourth side 656, respectively. The third extension protrusion 6593 and the fourth extension protrusion 6594 are provided on the second side 654 and the fourth side 656, respectively. The first extension block 6591 defines a first limiting groove 6571 extending through the first mating surface 6591a. The second extension block 6592 defines a second limiting groove 6572 extending through the second mating surface 6592a. The third extension block 6593 defines a first holding slot 6573 extending through the third mating surface 6593a. The fourth extension block 6594 defines a second holding slot 6574 extending through the fourth mating surface 6594a. The first holding slot 6573 divides the third extension protrusion 6593 into a first extension insertion block 6593b and a second extension insertion block 6593c. The second holding slot 6574 divides the fourth extension protrusion 6594 into a third extension insertion block 6594b and a fourth extension insertion block 6594c. Two terminal receiving holes 650 are provided for allowing the second contact arms 621 of the second conductive terminals 62 to be inserted therein, respectively. In the illustrated embodiment of the present disclosure, the insulating block 65 is generally of a cuboid shape. Correspondingly, the metal shield surrounding member 66 is generally of a cuboid shape. In one embodiment of the present disclosure, the metal shield surrounding member 66 is fixed on the insulating block 65 by soldering or welding. Of course, in other embodiments, the insulating block 65 can also be fixed in the metal shield surrounding member 66 in other ways.

During assembling, the second terminal module 60 is at least partially inserted into the insulating block 65. The second contact arms 621 of the second conductive terminals 62 are inserted into the corresponding terminal receiving holes 650. The first inserting block 6110 is inserted into the first holding slot 6573. At the same time, the first extension insertion block 6593b and the second extension insertion block 6593c are inserted into the first opening 6111 and the second opening 6112, respectively. The second inserting block 6120 is inserted into the second holding slot 6574. At the same time, the third extension insertion block 6594b and the fourth extension insertion block 6594c are inserted into the third opening 6121 and the fourth opening 6122, respectively.

Preferably, a plurality of first interference ribs 6110a are provided on two sides of the first inserting block 6110. The first interference ribs 6110a are configured to abut against the inner surfaces of the first extension insertion block 6593b and the second extension insertion block 6593c to increase the holding force. Similarly, a plurality of second interference ribs 6120a are provided on two sides of the second inserting block 6120. The second interference ribs 6120a are configured to abut against the inner surfaces of the third extension insertion block 6594b and the fourth extension insertion block 6594c to increase the holding force.

Besides, in the illustrated embodiment of the present disclosure, the first inserting block 6110 includes a first surface 6110b which is flush with the second side 654. The second inserting block 6120 includes a second surface 6120b which is flush with the fourth side 656.

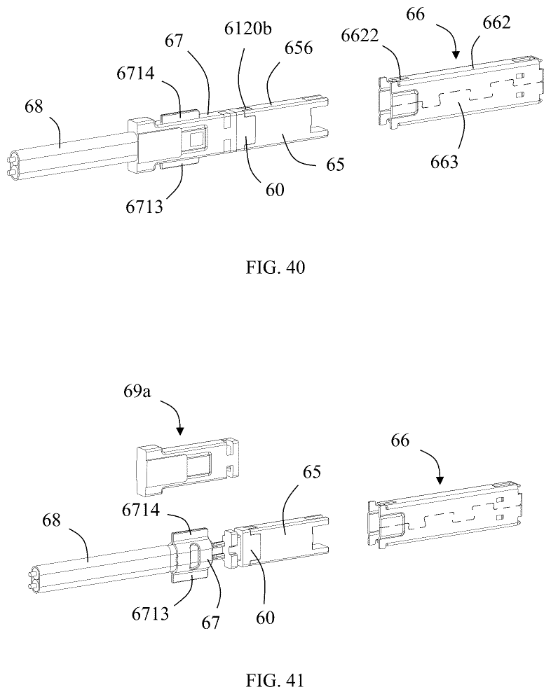

Referring to FIG. 39, each second cable 68 includes a second core 681 for electrically connecting with the second tail portion 622 of the second signal differential pair, a second insulating layer 682 wrapped around the second core 681, a shielding layer 683 wrapped around the second insulating layer 682, and an insulating outer layer 684 at least partially wrapped around the shielding layer 683. In one embodiment of the present disclosure, the second core 681 and the second tail portion 622 of the second signal differential pair are fixed by soldering or welding. In the illustrated embodiment of the present disclosure, for each second cable 68 itself, the shielding layer 683 is partially exposed to the insulating outer layer 684 to contact the second shielding clamping plate 67. The shielding layer 683 may be a braided layer made of metal wires to achieve a better ground shielding effect.

Of course, it is understandable to those skilled in the art that the second cable 68 can be a single ground wire cable, a double ground wire cable or a non-ground wire cable in the prior art. When the second cable 68 adopts the single ground wire cable or the double ground wire cable, the ground wire is in contact with the second shielding clamping plate 67 to achieve the ground conduction. When the second cable 68 adopts the non-ground wire cable, the second cable 68 is provided with the shielding layer 683, and the shielding layer 683 is in contact with the second shielding clamping plate 67 to achieve the ground conduction.

In the illustrated embodiment of the present disclosure, the second shielding clamping plate 67 is made of metal material. The second shielding clamping plate 67 includes a third clamping plate portion 671 and a fourth clamping plate portion 672. The third clamping plate portion 671 and the fourth clamping plate portion 672 are clamped and fixed on the second cable 68. The third clamping plate portion 671 and the fourth clamping plate portion 672 are both in contact with the shielding layer 683. In the illustrated embodiment of the present disclosure, the shielding layer 683 is sandwiched between the third clamping plate portion 671 and the fourth clamping plate portion 672.

In the illustrated embodiment of the present disclosure, the third clamping plate portion 671 includes a third clamping portion 6710, a fifth tab portion 6711 extending from a top end of the third clamping portion 6710 and a sixth tab portion 6712 extending from a bottom end of the third clamping portion 6710. The third clamping portion 6710 has an arc-shaped third inner surface 6710a and a third opening 6710b extending through the third clamping portion 6710.

The fourth clamping plate portion 672 includes a fourth clamping portion 6720, a seventh tab portion 6721 extending from a top end of the fourth clamping portion 6720, and an eighth tab portion 6722 extending from a bottom end of the fourth clamping portion 6720. The fourth clamping portion 6720 has an arc-shaped fourth inner surface 6720a and a fourth opening 6720b extending through the fourth clamping portion 6720.

The third clamping portion 6710 and the fourth clamping portion 6720 jointly clamp the second cable 68. The third opening 6710b and the fourth opening 6720b are configured to be filled with solder, so that the second shielding clamping plate 67 and the shielding layer 683 can be easily soldered.

In the illustrated embodiment of the present disclosure, the fifth tab portion 6711 and the seventh tab portion 6721 are abutted together to form a third insertion tab 6713. The sixth tab portion 6712 and the eighth tab portion 6722 are abutted together to form a fourth insertion tab 6714. Both the third insertion tab 6713 and the fourth insertion tab 6714 are in contact with the metal shielding sleeve 26.

In an embodiment of the present disclosure, the second covering block 69a is over-molded on the second terminal module 60, the second shielding clamping plate 67 and the second cable 68, so as to be integrated with the second terminal module 60, the second shielding clamping plate 67 and the second cable 68 as a whole. Specifically, the second covering block 69a is embedded in the first recessed groove 615 and the second recessed groove 616 of the insulative block 61 to improve the bonding reliability thereof. The third insertion tab 6713 and the fourth insertion tab 6714 respectively extend and protrude beyond the second covering block 69a.

In the illustrated embodiment of the present disclosure, the metal shield surrounding member 66 is generally of a cuboid shape, which includes a first side end wall 661 (for example, a top wall), a second side end wall 662 (for example, a bottom wall) opposite to the first side end wall 661, a third side end wall 663 (for example, a left side wall) connecting one end of the first side end wall 661 and one end of the second side end wall 662, and a fourth side end wall 664 (for example, a right side wall) connecting another end of the first side end wall 661 and another end of the second side end wall 662. The metal shield surrounding member 66 defines a receiving cavity 660 which is jointly enclosed by the first side end wall 661, the second side end wall 662, the third side end wall 663 and the fourth side end wall 664.

The metal shield surrounding member 66 is further provided with a port portion 665 and a deflection portion 666 bent inwardly from two sides of the port portion 665. By providing the deflection portion 666, a shrinking opening can be formed at the end of the metal shield surrounding member 66, so that the metal shield surrounding member 66 can be easily guided and inserted into the shielding cavity 260 of the first electrical connector 100.

In the illustrated embodiment of the present disclosure, the first side end wall 661 and the second side end wall 662 are located on short sides of the cuboid. The third side end wall 663 and the fourth side end wall 664 are located on long sides of the cuboid. A front end of the first side end wall 661 is provided with a first bulge 6611 protruding inwardly. A third slot 6612 is provided at a rear end of the first side end wall 661. Similarly, a front end of the second side end wall 662 is provided with a second bulge 6621 protruding inwardly. A fourth slot 6622 is provided at a rear end of the second side end wall 662. In the illustrated embodiment of the present disclosure, the metal shield surrounding member 66 is further provided with a reflective piece which is bent from the port portion 665 and extends into the receiving cavity 660. The reflective piece protrudes into the accommodating space 6590. Specifically, the third side end wall 663 includes a first reflective piece 6631 that is bent from the port portion 665 and extends into the receiving cavity 660. The first reflective piece 6631 at least partially abuts against an inner wall surface of the third side end wall 663. Similarly, the fourth side end wall 664 includes a second reflective piece 6641 which is bent from the port portion 665 and extends into the receiving cavity 660. The second reflective piece 6641 at least partially abuts against an inner wall surface of the fourth side end wall 664. The reflective piece includes the first reflective piece 6631 and the second reflective piece 6641. The first reflective piece 6631 and the second reflective piece 6641 both protrude into the accommodating space 6590.

During assembling, the second tail portion 622 of the second terminal module 60 is connected to the second cable 68 (for example, by soldering or welding). Then, the second shielding clamping plate 67 is fixed to the shielding layer 683. Then, the assembled parts are assembled with the insulating block 65. For example, the aforementioned assembled parts are inserted into the insulating block 65. At this time, the second contact arm 621 of the second conductive terminal 62 is received in the terminal receiving hole 650. Then, the second covering block 69a is over-molded on the assembled parts. Then, the aforementioned components are assembled with the metal shield surrounding member 66. For example, the aforementioned components are inserted into the metal shield surrounding member 66. At this time, the third insertion tab 6713 is inserted into the third slot 6612; and the fourth insertion tab 6714 is inserted into the fourth slot 6622. Preferably, the third insertion tab 6713 is further fixed to the first side end wall 661 by soldering or welding after being inserted into the third slot 6612. The fourth insertion tab 6714 is further fixed to the second side end wall 662 by soldering or welding after being inserted into the fourth slot 6622. The first bulge 6611 is fixed in the first limiting groove 6571. The second bulge 6621 is fixed in the second limiting groove 6572. It is understandable to those skilled in the art that by providing the first extension block 6591 and the second extension block 6592, the first bulge 6611 and the second bulge 6621 are blocked by the first extension block 6591 and the second extension block 6592, respectively, so as not to be exposed to the receiving cavity 660.

It is understandable to those skilled in the art that in the illustrated embodiment of the present disclosure, the shielding layer 683 is in contact with the second shielding clamping plate 67, and the second shielding clamping plate 67 is in contact with the metal shield surrounding member 66. With this arrangement, the shielding layer 683, the second shielding clamping plate 67 and the metal shield surrounding member 66 form a ground shielding structure connected in series, thereby improving the quality of signal transmission.

When the first conductive terminals 22 of the first electrical connector 100 is separated from the second conductive terminals 62 of the second electrical connector 200, the first conductive terminals 22 of the first electrical connector 100 pass through the first extension block 6591 and the second extension block 6592. At this time, the first extension block 6591 and the second extension block 6592 are able to reduce the degree of change in dielectric constant caused by the air medium surrounding the signal terminal pair, thereby playing a role of adjusting impedance.

Besides, by providing the first reflective piece 6631 and the second reflective piece 6641, the present disclosure is able to adjust the impedance of the signal terminal to a certain extent. Therefore, when the first electrical connector 100 and the second electrical connector 200 change from a mating state to a separated state, the impedance change of the signal terminal can be suppressed as much as possible and the impedance of the signal terminal can be kept stable.

In the illustrated embodiment of the present disclosure, a plurality of second mating modules 6 are provided on the electrical connector 200, and each two adjacent second mating modules 6 are disposed in a staggered manner. When the second mating modules 6 are mounted to the second housing 5, the metal shield surrounding members 66 of the second mating modules 6 pass through corresponding second terminal receiving grooves 511 to extend into in the receiving space 535.

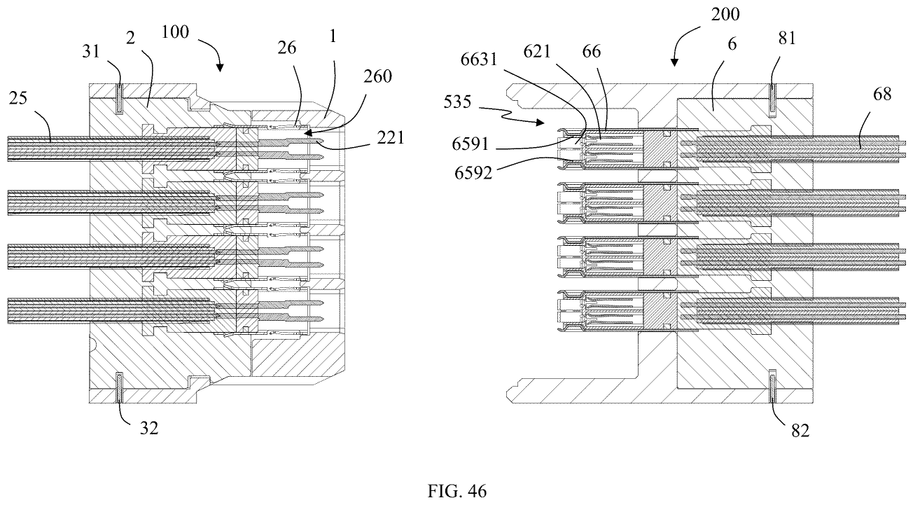

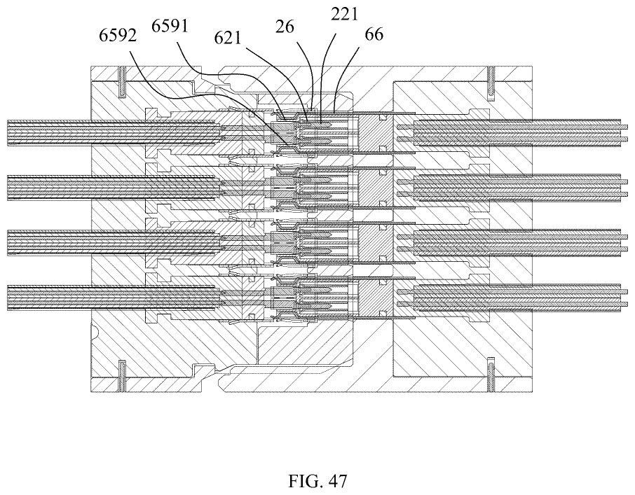

Referring to FIG. 46 and FIG. 47, when the first electrical connector 100 is mated with the second electrical connector 200, the first housing 1 of the first electrical connector 100 is partially inserted into the in the receiving space 535 of the second housing 5 of the second electrical connector 200. The metal shield surrounding member 66 of the second cable module 6a passes through the corresponding first terminal receiving groove 112 and is at least partially inserted into the shielding cavity 260 of the first cable module 2a. The first contact elastic arm 2611 and the second contact elastic arm 2612 of the metal shielding sleeve 26 are both in contact with the first side end wall 661 of the metal shield surrounding member 66. The third contact elastic arm 2621 and the fourth contact elastic arm 2622 of the metal shielding sleeve 26 are both in contact with the second side end wall 662 of the metal shield surrounding member 66. The first contact portion 221 of the first conductive terminal 22 is inserted into the second contact arm 621 of the second conductive terminal 62 to achieve electrical conduction. By providing the metal shield surrounding member 66 and the metal shielding sleeve 26 which surround the first contact portion 221 and the second contact arm 621, the present disclosure improves the signal shielding effect and the quality of signal transmission.

During the process of the first electrical connector 100 being separated from the second electrical connector 200 along the first direction Al-A1, when the first contact portion 221 of the first conductive terminal 22 has just separated from the second contact arm 621 of the second conductive terminal 62, the first contact portion 221 of the first conductive terminal 22 is located between the first reflective piece 6631 and the second reflective piece 6641 in the second direction A2-A2, and the first contact portion 221 of the first conductive terminal 22 is located between the first extension block 6591 and the second extension block 6592 in the third direction A3-A3. As the first contact portion 221 of the first conductive terminal 22 is further pulled out, the first reflective piece 6631 and the second reflective piece 6641 are able to adjust the impedance of the signal terminal to a certain extent. As a result, the impedance change of the signal terminal can be suppressed as much as possible to stabilize the impedance of the signal terminal. At the same time, the first extension block 6591 and the second extension block 6592 are able to replace air as a medium to suppress the impedance of the signal terminal, thereby playing an impedance adjustment role. Finally, when the first electrical connector 100 and the second electrical connector 200 change from the mating state to the separated state, the impedance change of the signal terminal can be suppressed as much as possible, so that the impedance of the signal terminal is kept stable.

It should be noted that, in order to facilitate understanding of the technical solution of the present disclosure, the component names starting with “first”, “second”, “third” . . . “eighth”, etc., in the present disclosure is only a naming method used to specifically introduce the technical solution of the present disclosure in conjunction with the illustrated embodiments of the present disclosure. If the names of these components do not start with “first”, “second”, “third” . . . “eighth”, etc., the names of these components are the superordinate concept of the component names starting with “first”, “second”, “third” . . . “eighth”, etc. For example, “the electrical connector” is a superordinate concept of “the first electrical connector 100” and “the second electrical connector 200”.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A second electrical connector, comprising:
a second housing, the second housing defining a receiving space and a plurality of second terminal receiving grooves communicating with the receiving space; the receiving space being configured to at least partially receive a first electrical connector; the second terminal receiving groove extends along a first direction; and
a second mating module, the second mating module being mounted to the second housing; the second mating module comprising a plurality of second cable modules and a second fixing block fixed on the plurality of second cable modules;
each second cable module comprising a second terminal module, a second cable electrically connected to the second terminal module, a second shielding clamping plate clamping the second cable, and a metal shield surrounding member at least partially sleeved on the second terminal module;
the second terminal module comprising a second conductive terminal; the second conductive terminal comprising a second contact arm and a second tail portion; the second tail portion being electrically connected to the second cable;
wherein the second shielding clamping plate comprises a third clamping plate portion and a fourth clamping plate portion; the second cable is clamped by the third clamping plate portion and the fourth clamping plate portion; the third clamping plate portion and the fourth clamping plate portion are provided separately from the metal shield surrounding member; and
wherein the second shielding clamping plate is in contact with the metal shield surrounding member; the metal shield surrounding member at least partially passes through a corresponding second terminal receiving groove to protrude into the receiving space.

2. The second electrical connector according to claim 1, wherein the metal shield surrounding member comprises a first side end wall, a second side end wall opposite to the first side end wall, a third side end wall connecting one end of the first side end wall and one end of the second side end wall, and a fourth side end wall connecting another end of the first side end wall and another end of the second side end wall; the metal shield surrounding member defines a receiving cavity jointly enclosed by the first side end wall, the second side end wall, the third side end wall and the fourth side end wall.

3. The second electrical connector according to claim 2, wherein the metal shield surrounding member comprises a port portion;
the third side end wall comprises a first reflective piece which is bent from the port portion and extends into the receiving cavity; the first reflective piece at least partially abuts against an inner wall surface of the third side end wall;
the fourth side end wall comprises a second reflective piece which is bent from the port portion and extends into the receiving cavity; the second reflective piece at least partially abuts against an inner wall surface of the fourth side end wall;
the first reflective piece and the second reflective piece are configured to adjust impedance of the second conductive terminal.

4. The second electrical connector according to claim 2, wherein the first side end wall defines a third slot, the second side end wall defines a fourth slot;
the second shielding clamping plate comprises a third insertion tab and a fourth insertion tab; the third insertion tab is at least partially inserted into the third slot; the fourth insertion tab is at least partially inserted into the fourth slot.

5. The second electrical connector according to claim 4, wherein the second shielding clamping plate is made of metal material;
the third clamping plate portion comprises a third clamping portion, a fifth tab portion extending from one end of the third clamping portion, and a sixth tab portion extending from another end of the third clamping portion;
the fourth clamping portion comprises a fourth clamping portion, a seventh tab portion extending from one end of the fourth clamping portion, and an eighth tab portion extending from another end of the fourth clamping portion;
wherein the second cable is clamped between the third clamping portion and the fourth clamping portion; the fifth tab portion and the seventh tab portion are abutted together to form the third insertion tab; the sixth tab portion and the eighth tab portion are abutted together to form the fourth insertion tab.

6. The second electrical connector according to claim 5, wherein the second cable comprises a second core electrically connected to the second tail portion of the second conductive terminal, a second insulating layer wrapped around the second core, and a shielding layer wrapped around the second insulating layer;
the shielding layer is clamped between the third clamping portion and the fourth clamping portion; the third clamping portion defines a third opening extending through the third clamping portion; the fourth clamping portion defines a fourth opening extending through the fourth clamping portion; the shielding layer is at least partially exposed in the third opening and the fourth opening; the third opening and the fourth opening are configured to be filled with solder to be soldered and fixed with the second cable.

7. The second electrical connector according to claim 2, wherein the second cable module comprises an insulating block; the insulating block comprises a first end surface, a second end surface opposite to the first end surface, a terminal receiving hole extending through the first end surface and the second end surface, a first extension block protruding from the first end surface and located on one side of the insulating block, and a second extension block protruding from the first end surface and located on another side of the insulating block; the first extension block defines a first limiting groove; the second extension block defines a second limiting groove;
the second contact arm of the second conductive terminal is received in the terminal receiving hole;
the metal shield surrounding member is sleeved on the insulating block; the first side end wall comprises a first bulge fixed in the first limiting groove; the second side end wall comprises a second bulge fixed in the second limiting groove.

8. The second electrical connector according to claim 7, wherein the insulating block further defines an accommodating space located between the first extension block and the second extension block; the metal shield surrounding member comprises a reflective piece that at least partially protrudes into the receiving cavity; the reflective piece also protrudes at least partially into the accommodating space.

9. The second electrical connector according to claim 7, wherein the first extension block comprises a first mating surface through which the first limiting groove extends along the first direction;
the second extension block comprises a second mating surface through which the second limiting groove extends along the first direction;
the first bulge and the second bulge are blocked by the first extension block and the second extension block, respectively, so as not to be exposed in the receiving cavity.

10. The second electrical connector according to claim 7, wherein the insulating block comprises a third extension block protruding from the second end surface and located on one side of the insulating block, and a fourth extension block protruding from the second end surface and located on another side of the insulating block;
the third extension block comprises a third mating surface and a first holding slot extending through the third mating surface along the first direction; the fourth extension block comprises a fourth mating surface and a second holding slot extending through the fourth mating surface along the first direction;
the second terminal module comprises an insulative block; the second conductive terminal is fixed to the insulative block; the insulative block comprises a first inserting block at least partially inserted into the first holding slot and a second inserting block at least partially inserted into the second holding slot.

11. The second electrical connector according to claim 7, wherein the second cable module comprises a second covering block at least partially fixed on the second terminal module, the second shielding clamping plate and the second cable; the second covering block is at least partially received in the receiving cavity of the metal shield surrounding member.

12. A connector assembly, comprising: a first electrical connector and a second electrical connector that cooperate with each other;
the first electrical connector comprising:
a first housing, the first housing comprising a mating surface and a plurality of first terminal receiving grooves extending through the mating surface; and
a first mating module, the first mating module comprising a first terminal module and a metal shielding sleeve at least partially sleeved on the first terminal module;
wherein the first terminal module comprises a first conductive terminal, the first conductive terminal comprises a first contact portion;
wherein the metal shielding sleeve comprises a first side wall, a second side wall opposite to the first side wall, a third side wall connecting one end of the first side wall and one end of the second side wall, and a fourth side wall connecting another end of the first side wall and another end of the second side wall; the metal shielding sleeve further comprises a shielding cavity jointly enclosed by the first side wall, the fourth side wall, the second side wall and the third side wall; the shielding cavity being disposed corresponding to a corresponding first terminal receiving groove; the first contact portion at least partially protrudes into the shielding cavity;
the second electrical connector comprising:
a second housing, the second housing defining a receiving space and a plurality of second terminal receiving grooves communicating with the receiving space; the second terminal receiving groove extends along a first direction; and
a second mating module, the second mating module comprising a plurality of second cable modules and a second fixing block fixed on the plurality of second cable modules;
each second cable module comprising a second terminal module, a second cable electrically connected to the second terminal module, a second shielding clamping plate clamping the second cable, and a metal shield surrounding member at least partially sleeved on the second terminal module;
the second terminal module comprising a second conductive terminal; the second conductive terminal comprising a second contact arm and a second tail portion; the second tail portion being electrically connected to the second cable;
wherein the second shielding clamping plate comprises a third clamping plate portion and a fourth clamping plate portion; the second cable is clamped by the third clamping plate portion and the fourth clamping plate portion;
wherein the second shielding clamping plate is in contact with the metal shield surrounding member; the metal shield surrounding member at least partially passes through a corresponding second terminal receiving groove to protrude into the receiving space;
when the first electrical connector is mated with the second electrical connector, the first housing of the first electrical connector is at least partially received in the receiving space of the second housing; the metal shield surrounding member of the second electrical connector is at least partially inserted into the shielding cavity of the first electrical connector; the first contact portion of the first electrical connector is in contact with the second contact arm of the second electrical connector.

13. The connector assembly according to claim 12, wherein the first mating module comprises a plurality of first cable modules and a first fixing block fixed on the plurality of first cable modules; the first fixing block is mounted to the first housing;
each first cable module comprises the first terminal module, the metal shielding sleeve and a first cable electrically connected to the first conductive terminal.

14. The connector assembly according to claim 12, wherein the first side wall comprises a hollow portion, a first contact elastic arm extending into the hollow portion and a second contact elastic arm extending into the hollow portion; the first contact elastic arm and the second contact elastic arm extend in opposite directions; both the first contact elastic arm and the second contact elastic arm at least partially protrude into the shielding cavity to abut against the metal shield surrounding member of the second electrical connector.

15. The connector assembly according to claim 13, wherein the first cable module comprises a first shielding clamping plate that clamps the first cable; the first shielding clamping plate is in contact with the metal shielding sleeve.

16. The connector assembly according to claim 15, wherein the first side wall defines a first slot, the second side wall defines a second slot;
the first shielding clamping plate comprises a first insertion tab at least partially inserted into the first slot and a second insertion tab at least partially inserted into the second slot.

17. The connector assembly according to claim 16, wherein the first cable comprises a first ground wire;
the first shielding clamping plate is made of metal material; the first shielding clamping plate comprises a first clamping plate portion and a second clamping plate portion;
the first clamping plate portion comprises a first clamping portion, a first tab portion extending from one end of the first clamping portion, and a second tab portion extending from another end of the first clamping portion;
the second clamping plate portion comprises a second clamping portion, a third tab portion extending from one end of the second clamping portion, and a fourth tab portion extending from another end of the second clamping portion;
the first cable is clamped between the first clamping portion and the second clamping portion; the first tab portion and the third tab portion are abutted together to form the first insertion tab; the second tab portion and the fourth tab portion are abutted together to form the second insertion tab.

18. The connector assembly according to claim 12, wherein the metal shield surrounding member comprises a first side end wall, a second side end wall opposite to the first side end wall, a third side end wall connecting one end of the first side end wall and one end of the second side end wall, and a fourth side end wall connecting another end of the first side end wall and another end of the second side end wall; the metal shield surrounding member defines a receiving cavity jointly enclosed by the first side end wall, the second side end wall, the third side end wall and the fourth side end wall.

19. The connector assembly according to claim 18, wherein the metal shield surrounding member comprises a port portion;
the third side end wall comprises a first reflective piece which is bent from the port portion and extends into the receiving cavity; the first reflective piece at least partially abuts against an inner wall surface of the third side end wall;
the fourth side end wall comprises a second reflective piece which is bent from the port portion and extends into the receiving cavity; the second reflective piece at least partially abuts against an inner wall surface of the fourth side end wall;
the first reflective piece and the second reflective piece are configured to adjust impedance of the second conductive terminal.

20. The connector assembly according to claim 18, wherein the first side end wall defines a third slot, the second side end wall defines a fourth slot;
the second shielding clamping plate comprises a third insertion tab and a fourth insertion tab; the third insertion tab is at least partially inserted into the third slot; the fourth insertion tab is at least partially inserted into the fourth slot.
